(19) United States
(12) Patent Application Publication
(10) Pub. No.: US 2007/0223323 A1
(43) Pub. Date: Sep. 27, 2007

(54) Optical Pickup Device

(75) Inventor: Taichi Akiba, Saitama (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 10/593,905

(22) PCT Filed: Mar. 18, 2005
(86) PCT No.: PCT/JP05/04939

§ 371 Date: Sep. 22, 2006

(30) Foreign Application Priority Data
Mar. 30, 2004 (JP) 2004-100200

(51) Int. Cl. G11B 7/00

(52) U.S. Cl. 369/44.11; 369/53.2; 369/44.25

(57) ABSTRACT

An optical pickup device for irradiating a light from a light source onto an optical recording medium through an objective lens moved in a focal direction by an actuator, and for causing a signal detecting unit to receive a return light from the irradiated light, the optical pickup device including a threshold calculating unit 36 that obtains shape information on the optical recording medium in a diameter direction before recording and/or reproducing is performed on the optical recording medium, and that sets limits to access distances of the objective lens to the optical recording medium according to a plurality of positions of the optical recording medium in the diameter direction, respectively based on the obtained information on the shape, and a focus control unit 35 that restricts movement of the objective lens in the focal direction by the actuator based on the plurality of set limits to the access distances.

### TECHNICAL FIELD

The present invention relates to a pickup and an optical pickup device that avoids collision of an optical disk.

### BACKGROUND ART

A recording and reproducing device, such as a CD (Compact Disk) player/recorder or a DVD (Digital Video (Versatile) Disk) player/recorder, reads information recorded on an optical disk, such as a CD. In reading information, the recording and reproducing device emits a light beam from a light source included in a pickup of the recording and reproducing device onto an information recording surface of the optical disk, and detects a reflected light from the information recording surface.

The pickup also includes an actuator that drive-controls an objective lens. The objective lens converges the light beam emitted from the light source on the information recording surface. A focal point of the light beam irradiated onto the information recording surface is adjusted according to a distance between the objective lens and the information recording surface.

To perform such adjustment of the focal point, the CD player or the like controls the actuator by focus servo control. The actuator is controlled to drive-control the objective lens in a direction of an optical axis of the objective lens so that the light beam can be focused with an optimum focal point onto the information recording surface.

To irradiate the light beam with the optimum focal point, there is conventionally known a technique that detects a real focal point onto the information recording surface, and controls a position of the objective lens according to a deviation between the real focal point and an optimum focal point.

However, if the detected real focal point is in error, due to say surface warping of the optical disk, a scratch on the information recording surface or the like, the various problems can occur. For example, the position of the objective lens relative to the optical disk cannot be accurately detected. As a result, the objective lens or the like collides against the information recording surface of the optical lens. It is, therefore, necessary to accurately detect the position of the objective lens and control movement of the objective lens to avoid collision between the objective lens and the information recording surface.

A focus controller disclosed in Patent Document 1 determines whether there is a possibility of collision between the objective lens and the optical disk. Namely, the focus controller monitors two factors: a distance between the objective lens and the optical disk, and a velocity of the objective lens at which the objective lens approaches the optical disk.

Patent Document 1: Japanese Patent Application Laid-Open No. 2002-157758

### DISCLOSURE OF INVENTION

### Problem to be Solved by the Invention

In the conventional technique disclosed in the Patent Document 1, whether there is a possibility of collision between the objective lens and the optical disk by detecting the distance between the objective lens and the optical disk based on a focus error signal; however, a range in which the distance can be detected is narrower than a range in which the objective lens is moved. As a result, the detected distance between the objective lens and the optical disk is often in error. Furthermore, the objective lens is moved for a considerable distance when detecting the position of the optical disk performed when recording or reproducing of information on or from the optical disk is started. As a result, an error in the detected distance between the objective lens and the optical disk can be very conspicuous. If the objective lens performs a collision avoidance operation based on a wrong distance, the focus servo control cannot be closed.

The present invention has been achieved to solve the conventional problems. It is an object of the present invention to obtain an optical pickup device that can prevent collision between an objective lens and an information recording surface of an optical disk.

Means for Solving Problems

To solve the above problems and to achieve the above objects, according to the invention disclosed in claim 1, an optical pickup device for irradiating a light from a light source onto an optical recording medium through an objective lens moved in a focal direction by an actuator, and for causing a signal detecting unit to receive a return light from the irradiated light, includes an access limit introducing unit that obtains shape information on the optical recording medium in a diameter direction before recording and/or reproducing is performed on the optical recording medium, and that sets limits to access distances of the objective lens to the optical recording medium according to a plurality of positions of the optical recording medium in the diameter direction, respectively based on the obtained information on the shape; and a collision avoiding unit that restricts movement of the objective lens in the focal direction by the actuator based on the plurality of set limits to the access distances.

Moreover, according to the invention disclosed in claim 8, a collision preventing method of preventing collision between an objective lens moved by an actuator in a focal direction and an optical recording medium onto which a light is irradiated from a light source, includes a first step of obtaining shape information on the optical recording medium in a diameter direction before recording and/or reproducing is performed on the optical recording medium; a second step of setting limits to access distances of the objective lens to the optical recording medium according to a plurality of positions of the optical recording medium in the diameter direction, respectively based on the obtained shape information; and a third step of restricting movement of the objective lens in the focal direction by the actuator based on the plurality of set limits to the access distances.

### BRIEF DESCRIPTION OF DRAWINGS

FIG. 1 is schematic of a pickup according to a first embodiment of the present invention.

FIG. 2 is a block diagram of a disk-collision avoiding device according to the first embodiment.

FIG. 3 is a flowchart of an operation procedure for avoiding collision between an objective lens and an optical disk.

FIG. 4 is an example of a focus error signal.

FIG. 5 is schematic for explaining the relationship between focus drive currents and in-focus states calculated by the disk-collision avoiding device.

FIG. 6 is a graph for explaining the method of calculating thresholds of the focus drive currents.

FIG. 7 is a schematic of a pickup according to a second embodiment of the present invention.

FIG. 8 is a block diagram of a disk-collision avoiding device according to the second embodiment.

FIG. 9 is a schematic for explaining the relationship between moving distances of an objective lens and in-focus states calculated by the disk-collision avoiding device.

FIG. 10 is a schematic of a pickup according to a third embodiment of the present invention.

FIG. 11 is a block diagram of a disk-collision avoiding device according to the third embodiment.

### EXPLANATIONS OF LETTERS OR NUMERALS

1-3 Disk-collision avoiding device

10 Pickup

15 Signal detecting unit

16, 46 Objective-lens driving unit

20 Objective lens holder

21 Focus coil

22 Objective lens

31 Focus driving unit

32 Drive-current detecting unit

34 Radial-position detecting unit

35 Focus control unit

36 Threshold calculating unit

37 Storing unit

42 Moving-distance calculating unit

45 Position sensor

55 Mechanical stopper

57 Coil

58 Stopper unit

59 Mechanical stopper driving unit

70 Optical disk

### BEST MODE(S) FOR CARRYING OUT THE INVENTION

Exemplary embodiments of an optical pickup device according to the present invention will be explained hereinafter. The present invention is not limited to the embodiments. Outline and features of the optical pickup device according to the present invention will be explained as the embodiments, and the embodiments of the optical pickup device will be specifically explained.

### EMBODIMENTS

According to the embodiments of the present invention, a digital signal recording and reproducing device such as a CD (Compact Disk) player or a CD recorder includes a pickup device (i.e., an optical pickup device) or the like as a device that reads information recorded on an optical disk. The pickup device includes an actuator. The actuator drives an objective lens to control a focus i.e., focal point, of a light beam irradiated onto the optical disk. Furthermore, a disk-collision avoiding device included in the optical pickup device provides control to avoid collision between a head of an objective lens or the like employed to record or reproduce information on and from an optical recording medium (optical disk) and the optical disk when the information recorded on the optical disk is reproduced or recorded.

The focal point of the light beam irradiated onto the optical disk is adjusted according to the distance between the objective lens and the optical disk. The objective lens is driven such that the focal point is optimum.

A focus error signal is a signal indicative of the distance between the objective lens and the optical disk. From the focus error signal, the distance between the objective lens and the optical disk can be detected. Therefore, by using the focus error signal, the collision between the objective lens and the optical disk can be avoided.

Basically, the focus error signal indicates a zero level (to be exact, a zero-crossing point from a maximal point to a minimal point) in an in-focus state in which the focus of the objective lens is on the recording surface. The focus error signal draws an S-curve around the zero level from the maximal point to the minimal point, i.e., a focal point. In addition, the focus error signal exhibits linearity only in a range from the maximal point to the minimal point on one S-curve (which is a range of about ten micrometers from a focal position).

Meanwhile, the distance between the objective lens and the optical disk is about several hundreds micrometers to two millimeters when the objective lens is the in-focus state. Therefore, the distance between the objective lens and the optical disk that can be recognized by detecting the focus error signal is far smaller than the range in which the objective lens is moved.

Moreover, to control a collision avoidance operation for avoiding collision between the objective lens and the optical disk (an operation of keeping the objective lens away from the optical disk or the like) according to the distance between the objective lens and the optical disk, the following method is known. A threshold of the focus error signal for the collision avoidance operation is set within a capture range (about ten micrometers) of the focus error signal. However, an operation of detecting the position of the optical disk performed when reproducing of information from the optical disk is started is executed by greatly moving the objective lens. Due to this, when the reproducing of information from the optical disk is started, the focus error signal often exceeds the threshold for determining whether to perform the collision avoidance operation. If the focus error signal exceeds the threshold for determining whether to perform the collision avoidance operation, the objective lens performs the collision avoidance operation. As a result, the focus servo control cannot be closed.

According to the embodiments of the present invention, the following measures are taken. The relationship between information on a position of the objective lens relative to the pickup device (a focal direction distance) and the focus error signal is obtained in advance as shape information on the optical disk (optical recording medium). A plurality of limits to an access distance (hereinafter, also “access distance limits”) of the objective lens to the optical disk are set according to positions of the optical recording medium in a diameter direction. The actuator restricts movement of the objective lens in the focal direction based on the access distance limits, and the collision between the objective lens and the optical disk is avoided.

For instance, as the information on the position of the objective lens relative to the pickup device, a drive current for drive-controlling the movement of the objective lens relative to the pickup is used. The drive current can control a moving distance of the pickup according to a magnitude of the drive current.

Before recording or reproducing of the information on or from the optical disk, the focus error signal is detected while rotating the optical disk at a predetermined position on a surface of the optical disk. The in-focus state in which the focus of the objective lens is on the recording surface of the optical disk is detected based on the focus error signal. During detection, if a drive current I1 for moving the objective lens from a neutral position to a position of the in-focus state is measured, the drive current I1 in the in-focus state can be recognized. Furthermore, the distance between the objective lens and the optical disk in the in-focus state can be calculated from a wavelength of the light beam or the like. A drive current Iwd necessary to move the objective lens by the distance can be calculated. It, therefore, indicates that the objective lens collides against the optical disk when the drive current is equal to (I1+Iwd). For this reason, if a threshold (limiter) of the drive current for moving the objective lens is set at the measurement position based on the drive current (I1+Iwd), the collision between the objective lens and the optical disk can be avoided.

Thresholds of the drive current (access distance limits of the objective lens to the optical disk) are calculated at a plurality of locations on the surface of the optical disk (positions in the diameter direction different in a radial position from a center), respectively. Thresholds of the drive current on the entire surface of the optical disk are calculated based on the relationship between the positions of the optical disk in the diameter direction on the surface of the optical disk and the thresholds of the drive current.

When the information is actually recorded or reproduced on or from the optical disk, the movement or the like of the objective lens is controlled based on the thresholds of the drive current calculated in advance to avoid the collision between the objective lens and the optical disk if the drive current exceeds the corresponding threshold.

In this manner, according to the embodiments, the possible collision between the objective lens and the optical disk is detected without using the focus error signal during the recording or reproducing processing on the optical disk. Due to this, the position of the objective lens relative to the optical disk can be accurately detected even with a surface warping of the optical disk or the like, a scratch on the information recording surface or the like. Accordingly, it is possible to accurately avoid the collision between the objective lens and the optical disk.

The use of the disk collision avoiding device is not limited to a CD player or a CD recorder. The disk collision avoiding device can be also applied to a DVD (Digital Video (Versatile) Disk) player, a DVD recorder, a CD drive for a personal computer, a DVD drive for a personal computer or the like.

### First Embodiment

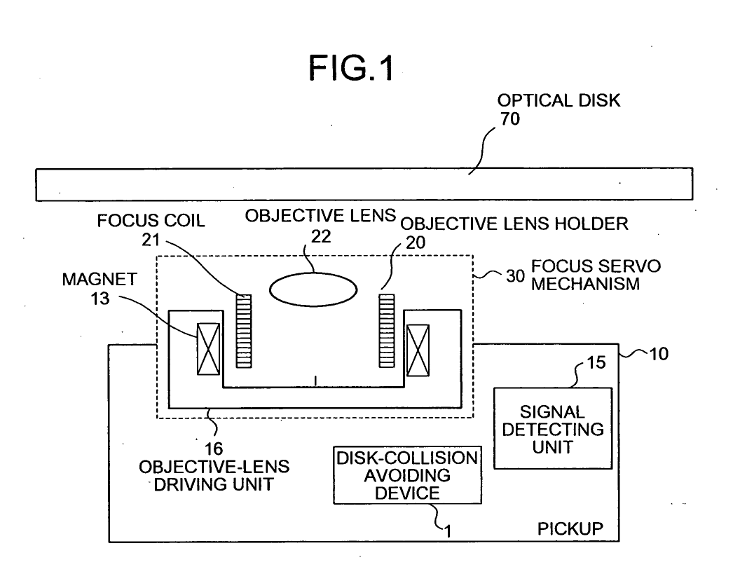

FIG. 1 is a schematic of a pickup according to a first embodiment of the present invention. A pickup 10 is moved in a plane direction parallel to an information recording surface of an optical disk 70 (hereinafter, “radial direction”). The pickup 10 irradiates a light beam onto the information recording surface of the optical disk 70, detects a reflected light from the optical disk 70, and reads information recorded on the optical disk 70.

The pickup 10 includes a focus servo mechanism 30, a signal detecting unit 15 that detects a reflected light from a light beam source (not shown) of the light beam irradiated on the optical disk 70, and a disk collision avoiding device 1. The focus servo mechanism 30 includes an objective lens holder 20 and an objective-lens driving unit 16.

The objective-lens driving unit 16 includes a magnet 13, which is a permanent magnet, and a yoke which is not shown. The objective lens holder 20 includes a focus coil 21 and an objective lens 22.

An electromagnetic force is generated on the focus coil 21 by applying a current to the focus coil 21. The objective lens holder 20 is moved on the objective-lens driving unit 16 in a light-beam irradiation direction (a direction perpendicular to the surface of the optical disk 70) by an attraction force or a repulsive force between the electromagnetic force and the magnet 13.

The objective lens 22 converges the light beam from the light beam source (not shown) irradiated onto the optical disk 70, and feeds the convergent beam to the optical disk 70. In addition, the objective lens 22 feeds the light beam reflected by the optical disk 70 to the signal detecting unit 15.

The signal detecting unit 15 includes a light receiving element such as a quadripartite detector (not shown). The light receiving element detects the reflected light of the light beam irradiated onto the optical disk 70 through the objective lens 22 from the optical disk 70. The signal detecting unit 15 detects a focus error signal or a reproduced signal from the reflected light from the optical disk 70, and supplies the detected focus error signal or reproduced signal to the disk collision avoiding device 1 to be explained later. The optical disk 70 is a recording medium on and from which a CD player/recorder records and reproduces information. The optical disk 70 is a disk such as CD or a DVD.

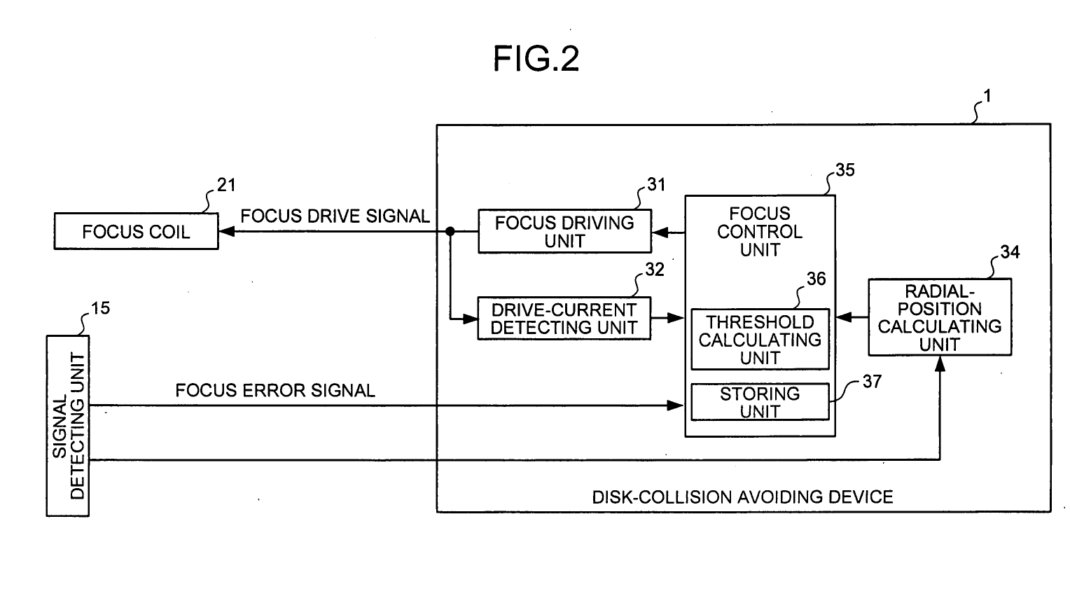

FIG. 2 is a block diagram of the disk collision avoiding device according to the first embodiment of the present invention. The disk collision avoiding device 1, which avoids the collision of the objective lens 22 against the optical disk 70, includes a focus driving unit 31, a drive-current detecting unit 32, a radial-position detecting unit 34, and a focus control unit (collision avoiding unit) 35.

The focus driving unit 31 is connected to the focus coil 21. The focus driving unit 31 applies a current to the focus coil 21 to drive the objective lens holder 20. The focus driving unit 31 controls a relative position of the objective lens 22 connected to the focus coil 21 to the pickup 10 by controlling an amount of the current (focus drive current) applied to the focus coil 21. Namely, the focus driving unit 31 can control the relative position of the objective lens 22 to the optical disk 70 by controlling the amount of the current applied to the focus coil 21.

The drive-current detecting unit 32 includes a measuring circuit that measures the amount of the focus drive current (DC component) applied by the focus driving unit 31 to the focus coil 21. The drive-current detecting unit 32 measures the focus drive current applied by the focus driving unit 31 to the focus coil 21.

The radial-position detecting unit 34 detects a distance of the objective lens 22 in a radial direction from a center of the information recording surface of the optical disk 70 (hereinafter, “radial distance”). The radial-position detecting unit 34 detects the radial distance of the objective lens 22 to the optical disk 70 based on, for example, address information in the reproduced signal read from the optical disk 70.

The focus control unit 35 includes a threshold calculating unit (an access limit introducing unit) 36 and a storing unit 37. The threshold calculating unit 36 makes the focus drive current and the radial distance of the objective lens 22 in the in-focus state (at a position at which the light beam is in optimum focal point) correspond to each other based on the focus drive current supplied from the drive-current detecting unit 32, the radial distance of the objective lens 22 supplied from the radial-position detecting unit 34, and the focus error signal supplied from the pickup 10.

The threshold calculating unit 36 makes the drive current and the radial distance of the objective lens 22 in the in-focus state correspond to each other at a plurality of positions (radial distances) of the optical disk 70. The threshold calculating unit 36 calculates at which position on the surface of the optical disk 70 the objective lens 22 is in the in-focus state with which focus drive current (calculates a warping of (shape information on) the optical disk 70). The threshold calculating unit 36 calculates thresholds of the focus drive current for the objective lens 22 based on the following information: information at which position the optical disk 70 the objective lens 22 is in the in-focus state with which focus drive current, and the focus drive current (corresponding to the focus drive current Iwd to be explained later) necessary to move the objective lens 22 in the in-focus state to a position at which the objective lens 22 collides against the optical disk 70.

The threshold calculating unit 36 calculates the thresholds of the focus drive current before a reproducing processing on the optical disk 70. If the focus drive current from the drive-current detecting unit 32 exceeds the corresponding threshold during the reproducing processing on the optical disk 70, the threshold calculating unit 36 transmits, to the focus driving unit 31, information on a command to control the movement of the focus coil 21.

The storing unit 37 stores therein the focus drive current Iwd necessary to move the objective lens 22 in the in-focus state to the position at which the objective lens 22 collides against the optical disk 70, and the thresholds of the focus drive current calculated before the reproducing processing on the optical disk 70.

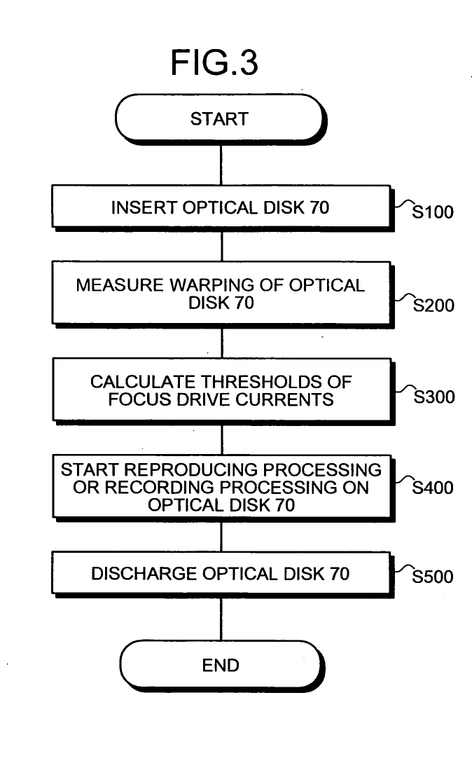

Operations performed by the respective constituent elements shown in FIGS. 1 and 2 will be explained while referring to the flowchart of FIG. 3. The optical disk 70 is inserted into the CD player or the like that includes the disk collision avoiding device 1 (step S100). When the optical disk 70 is inserted into the CD player, the threshold calculating unit 36 starts measuring the warping of the optical disk 70 before the reproducing or recording processing is performed on the optical disk 70.

The pickup 10 is moved in the plane direction parallel to the surface of the optical disk 70. When the pickup 10 is moved to a predetermined position (a position X1 to be explained later) at which the pickup 10 can read the information recorded on the optical disk 70, the focus control unit 35 transmits, to the focus driving unit 31, information on a command to drive the pickup 10. The focus driving unit 31 that receives the command information from the focus control unit 35 applies the current to the focus coil 21 of the pickup 10. The objective lens holder 20 including the objective lens holder 20 is thereby driven, and the light beam is irradiated onto the optical disk 70 that is being rotated.

The signal detecting unit 15 extracts the focus error signal from the reflected light from the optical disk 70, and transmits the focus error signal to the threshold calculating unit 36. Furthermore, the drive-current detecting unit 32 measures the focus drive current at time when the signal detecting unit 15 extracts the focus error signal of zero. The radial-position detecting unit 34 acquires the information (the address or the like of the optical disk 70) on the position at which the signal detecting unit 15 extracts the focus error signal from the reflected light (reproduced light) from the optical disk 70.

At this moment, the optical disk 70 is rotated. By measuring the focus error signal and the focus drive current for predetermined time at the position at which the focus error signal is extracted, an average focus error signal and an average focus drive signal at radial positions same in distance from the center are obtained.

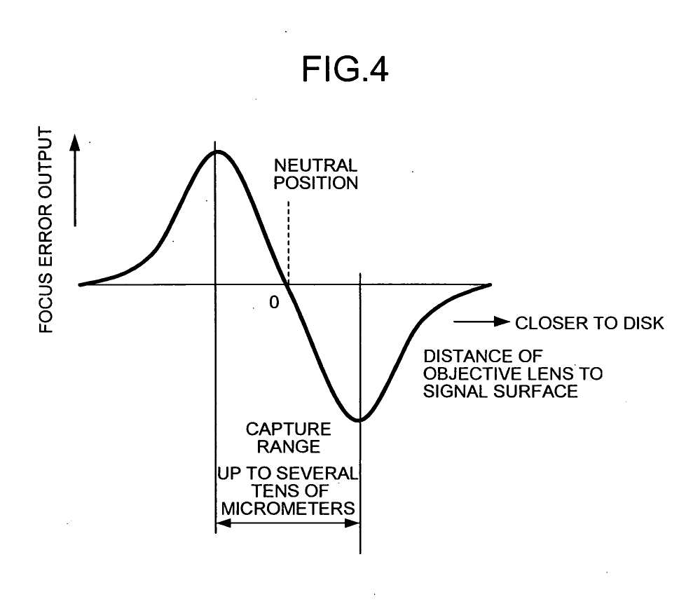

FIG. 4 is an example of the focus error signal. In FIG. 4, a horizontal axis indicates the distance (irradiation direction distance) between the objective lens 22 and the surface (signal surface) of the optical disk 70. A vertical axis indicates an output of the focus signal.

The output of the focus error signal (focus error output) is changed to draw an S-curve according to the distance between the objective lens 22 and the surface of the optical disk 70. The signal detecting unit 15 included in the pickup 10 is set so that the focus error signal is equal to zero when the light beam irradiated onto the optical disk 70 is in optimum focal point (when the objective lens 22 is in the in-focus state). Therefore, a distance y between the objective lens 22 and the surface of the optical disk 70 when the focus error signal is equal to zero is always a constant value (a distance WD to be explained later).

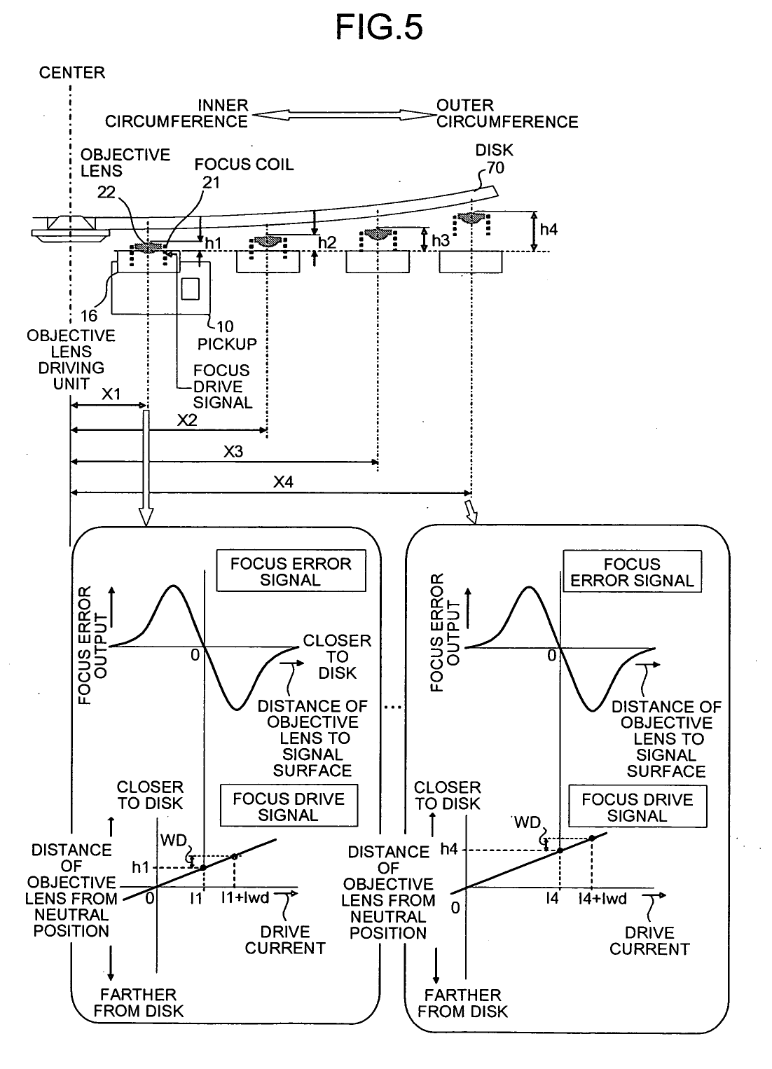

FIG. 5 is a schematic for explaining the relationship between the focus drive current and the in-focus state calculated by the disk-collision avoiding device. The pickup 10 reads the information recorded on the optical disk 70 in a state in which the optical disk 70 is rotated. The signal detecting unit 15 detects focus error signals at a plurality of positions X1 to Xn, respectively, from a closer position (inner position) (X1) to the center of the surface of the optical disk 70 to a farther position (outer position) (Xn (where n is a natural number)) from the center. The drive-current detecting unit 32 measures focus drive currents I1 to In corresponding to the focus error signal of zero.

At the position Xn, the objective lens 22 turns into the in-focus state when the objective lens 22 is moved from the objective-lens driving unit 16 (pickup 10) in the light-beam irradiation direction by a distance hn. The drive current at this time is assumed as the focus drive current In. It is also assumed that the distance hn between the objective-lens driving unit 16 and the objective lens 22 is a distance (distance from the neutral position) by which the objective lens 22 is moved from the position of the objective lens 22 relative to the objective-lens driving unit 16 when the focus servo control is open (inoperative) to the position in the in-focus state.

In the first embodiment, the following instance will be explained. The signal detecting unit 15 detects the focus error signal at the four positions (from the inner position (X1) to the outer position (X4) on the surface of the optical disk 70. The threshold calculating unit 36 measures the drive currents I1 to I4 corresponding to the focus error signal of zero at the respective positions X1 to X4.

The distance between the objective lens 22 and the surface of the optical disk 70 is changed according to the warping or deflection of the surface of the optical disk 70 or a mechanical dimensional error of an attachment position of a spindle motor (not shown) or the like. For instance, because of a difference in shape among a plurality of optical disks 70, distances hi to h4 by which the objective lens 22 is moved from the objective-lens driving unit 16 to irradiate the light beam with optimum focal point onto the optical disk 70 at the respective positions X1 to X4 differ among the optical disks 70. Furthermore, because of the warping of the optical disk 70 or the like on the surface of even one optical disk 70, the distances h1 to h4 differ according to radial positions of the objective lens 22. Due to this, the focus drive currents I1 to I4 for moving the objective lens 22 from the neutral position to the position in the in-focus state differ on the surface of the optical disk 70.

In the first embodiment, the signal detecting unit 15 detects the focus error signal first at the position X1, and the drive-current detecting unit 32 measures the focus drive current at the position X1. In addition, the radial-position detecting unit 34 acquires information on the position X1 at which the focus error signal is detected, and transmits the information to the focus control unit 35.

The pickup 10 is then moved to the radial position X2 other than the position X1 in the plane direction parallel to the surface of the optical disk 70. At the position X2, similarly to the position X1, the signal detecting unit 15 detects the focus error signal, and the drive-current detecting unit 32 measures the focus drive signal. In addition, the radial-position detecting unit 34 acquires information on the position X2 and transmits the information to the focus control unit 35.

The pickup 10 is further moved to the other radial positions X3 and X4 in the plane direction in parallel to the surface of the optical disk 70. The signal detecting unit 15 detects the focus error signals at the positions X3 and X4, respectively. The drive-current detecting unit 32 detects the focus drive currents at the positions X3 and X4, respectively. The radial-position detecting unit 34 acquires information on the respective positions X3 and X4, and transmits the information to the focus control unit 35.

The threshold calculating unit 36 makes the focus drive currents and the radial distances in the in-focus state (at the positions at which the light beam is with optimum focal point) correspond to each other based on the focus drive currents transmitted from the drive-current detecting unit 32, the radial distances of the objective lens 22 transmitted from the radial-position detecting unit 34, and the focus error signals transmitted from the pickup 10. In the first embodiment, the focus drive currents at which the focus error signal is equal to zero at the positions X1 to X4 correspond to the focus drive currents I1 to I4, respectively.

The storing unit 37 of the focus control unit 35 stores therein the focus drive currents I1 to I4 in the in-focus state at the respective positions X1 to X4 as the information on the shape (warping) of the optical disk 70 (step S200).

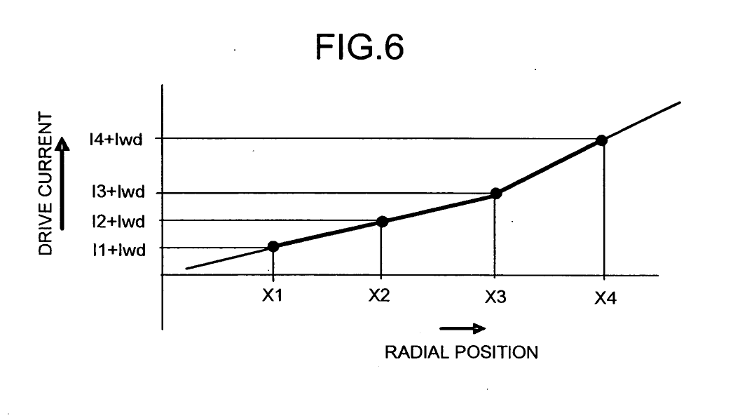

FIG. 6 is a graph for explaining a method of calculating the thresholds of the focus drive currents. The distance Wd between the objective lens 22 and the surface of the optical disk 70 when the focus error signal output is equal to zero (in the in-focus state) is calculated. By doing so, the focus drive current (applied since the objective lens 22 is in the in-focus state until the objective lens 20 collides against the optical disk 70) Iwd necessary to move the objective lens 22 by the distance WD can be calculated. Accordingly, the focus drive currents (hereinafter, “collision drive currents”) (I1+Iwd) to (I4+Iwd) when the objective lens 22 collides against the surface of the optical disk 70 at the respective positions X1 to X4 can be calculated.

As shown in FIG. 6, it is possible to calculate the collision drive currents corresponding to all the radial positions of the objective lens 22 on the optical disk 70 based on the relationship between the collision drive currents (I1+Iwd) to (I4+Iwd) and the positions X1 to X4 by linear interpolation or the like, respectively.

In the first embodiment, the threshold calculating unit 36 calculates the relationship between the collision drive currents (I1+Iwd) to (I4+Iwd) and the positions X1 to X4 based on the following information: the focus drive currents I1 to I4 in the in-focus state at the respective positions X1 to 4 (information on the warping of the optical disk), and the focus drive current Iwd necessary to move the objective lens 22 from the surface of the optical disk 70 by the distance WD.

The threshold calculating unit 36 calculates the collision drive currents corresponding to all the respective radial positions of the objective lens 22 on the surface of the optical disk 70 as information on the thresholds of the optical drive currents based on the relationship between the collision drive currents (I1+Iwd) to (I4+Iwd) and the positions X1 to X4 (step S300). The calculated information on the thresholds of the focus drive currents is stored in the storing unit 37.

Next, the CD drive starts the recording or reproducing processing on the optical disk 70 (step S400). When the pickup 10 is moved to the position at which the reproducing processing or the like is started in the plane direction parallel to the surface of the optical disk 70, the focus control unit 35 transmits, to the focus driving unit 31, the information on the command to drive the pickup 10. The focus driving unit 31 that receives the command information from the focus control unit 35 applies the focus drive current to the focus coil 21 of the pickup 10. The objective lens holder 20 including the objective lens 22 is driven accordingly, and the light beam is irradiated onto the optical disk 70.

During the recording or reproducing processing on the optical disk 70, the signal detecting unit 15 extracts the reproduced signal from the light beam reflected from the optical disk 70 and transmits the reproduced signal to the focus control unit 35. At this time, it is unnecessary for the signal detecting unit 15 to extract the focus error signal.

During the recording or reproducing processing on the optical disk 70, the drive-current detecting unit 32 measures the focus drive current. In addition, the radial-position detecting unit 34 acquires the information on the radial position of the objective lens 22 from the reproduced signal transmitted from the signal detecting unit 15. The focus drive current measured by the drive-current detecting unit 32 and the information on the radial position of the objective lens 22 acquired by the radial-position detecting unit 34 are transmitted to the threshold calculating unit 36.

The focus control unit 35 transmits the command information to the focus driving unit 31 based on the following information: the information on the thresholds of the focus drive currents stored before the reproducing processing on the optical disk 70, the focus drive current for the optical disk 70 that current is being measured by the drive-current detecting unit 32, and the information on the radial positions of the objective lens 22 acquired by the radial-position detecting unit 34. In the first embodiment, if the focus drive current measured by the drive-current detecting unit 32 at each radial position of the objective lens 22 is close to the collision drive current stored as the corresponding threshold information by a predetermined value, the focus control unit 35 transmits, to the focus driving unit 31, information on a command to move the objective lens 22 to be farther from the optical disk 70 or on a command to stop the movement of the objective lens 22.

Upon reception of the command information from the focus control unit 35, the focus driving unit 31 controls the amount of the current applied to the focus coil 21 based on the information from the focus control unit 35 to avoid the collision between the objective lens 22 and the optical disk 70.

When the CD drive finishes the recording or reproducing processing on the optical disk 70 and the optical disk 70 is discharged from the CD drive, the threshold information on the drive currents stored in the threshold calculating unit 36 is deleted (step S500). Alternatively, after the CD drive finishes the recording or reproducing processing on the optical disk 70, the threshold information on the drive currents stored in the threshold calculating unit 36 may be stored in the storing unit 37 until the optical disk 70 is discharged from the CD drive. By doing so, if the CD drive is turned on again after supply of power to the CD drive is stopped, it is unnecessary for the threshold calculating unit 36 to calculate again the threshold information on the drive currents. If the CD drive is turned on again after the supply of the power to the CD drive is stopped, the threshold information stored in the storing unit 37 is transmitted to the threshold calculating unit 36. The CD drive performs the recording or reproducing processing on the optical disk 70 based on the threshold information of the threshold calculating unit 36.

The focus drive currents differ in the distance, by which the objective lens 22 can be moved, according to frequencies. Due to this, if the focus drive currents at different frequencies are used, the focus control unit 35 is configured to include an equalizer or the like that corrects each focus drive current.

Moreover, in the first embodiment, the focus error signal is detected before the recording or reproducing processing on the optical disk 70 while the focus servo control is closed. Alternatively, the focus error signal can be detected while focus servo control is open. In this alternative, the in-focus state is detected by detecting the focus drive signals detected by the drive-current detecting unit 32 and the zero level of the focus error signal. This can reduce the misdetection of the focus error signal when the warping of the optical disk 70 is detected.

In this manner, according to the first embodiment, the thresholds of the focus drive currents are calculated before the recording or reproducing processing on the optical disk 70. Therefore, during the recording or reproducing processing on the optical disk 70, the distance between the objective-lens driving unit 16 and the objective lens 22 in the optical axis direction can be calculated by detecting the focus drive current. This makes it possible to estimate the irradiation direction distance of the objective lens 22 to the optical disk 70, and to reduce the misdetection of the irradiation direction distance of the objective lens 22 to the optical disk 70. Therefore, possibility of collision between the objective lens 22 and the optical disk 70 can be accurately estimated and the collision can be avoided. Furthermore, even while the focus servo control is open (inoperative), the collision between the objective lens 22 and the optical disk 70 can be avoided by detecting the focus drive currents.

### Second Embobiment

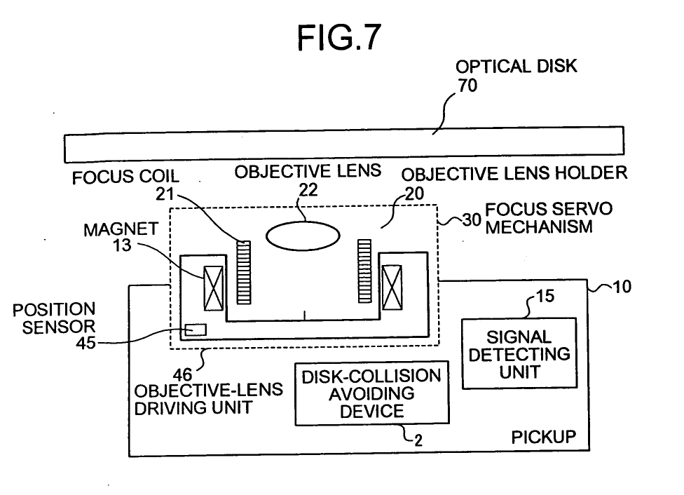

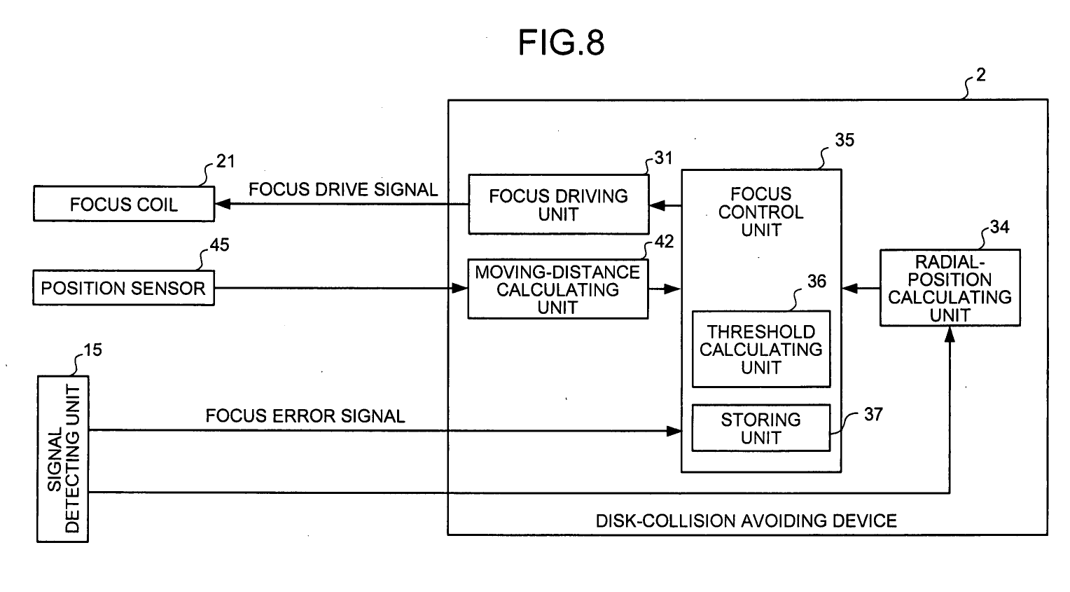

A second embodiment of the present invention will be explained with reference to FIGS. 7 and 8. In the second embodiment, a position sensor (distance measuring unit) 45 detects the distance between the objective lens 22 and the objective-lens driving unit 16 in a laser irradiation direction.

FIG. 7 is a schematic of a pickup according to the second embodiment. FIG. 8 is a block diagram of a disk collision avoiding device. In FIGS. 7 and 8, constituent elements that fulfill the same functions as those of the pickup 10 and the disk collision avoiding device 1 according to the first embodiment shown in FIGS. 1 and 2 are denoted by the same reference symbols, and will not be repeatedly explained.

As shown in FIG. 7, an objective-lens driving unit 46 of the pickup 10 includes the position sensor 45. The position sensor 45 detects the (irradiation direction) position of the objective lens 22 relative to the pickup 10 when the signal detecting unit 15 detects the focus error signal. The position of the objective lens 22 detected by the position sensor 45 is transmitted to a disk collision avoiding device 2 as an electric signal.

As shown in FIG. 8, the disk collision avoiding device 2 includes a moving distance calculating unit (moving distance measuring unit) 42. The moving distance calculating unit 42 calculates the electric signal transmitted from the position sensor 45 as a moving distance of the objective lens 22 relative to the objective-lens driving unit 16 using a measuring circuit which is not shown. The moving distance calculated by the moving distance calculating unit 42 is transmitted to the focus control unit 35.

The threshold calculating unit 36 calculates thresholds of moving amounts of the objective lens 22 used to control the movement of the objective lens 22 (access distance limits of the objective lens 22 to the optical disk 70) based on the following information: the focus error signals calculated by the signal detecting unit 15, the moving distance of the objective lens 22 relative to the pickup 10 calculated by the moving distance calculating unit 42, and the information on the positions X1 to X4 acquired by the radial-position detecting unit 34.

A procedure for avoiding collision between the objective lens 22 and the optical disk 70 in the second embodiment is the same as that explained in the first embodiment and will not be, therefore, explained. In the second embodiment, a method of calculating thresholds of moving amounts used to control the warping of the optical disk 70 and the movement of the objective lens 22, which method differs from the first embodiment, will be explained.

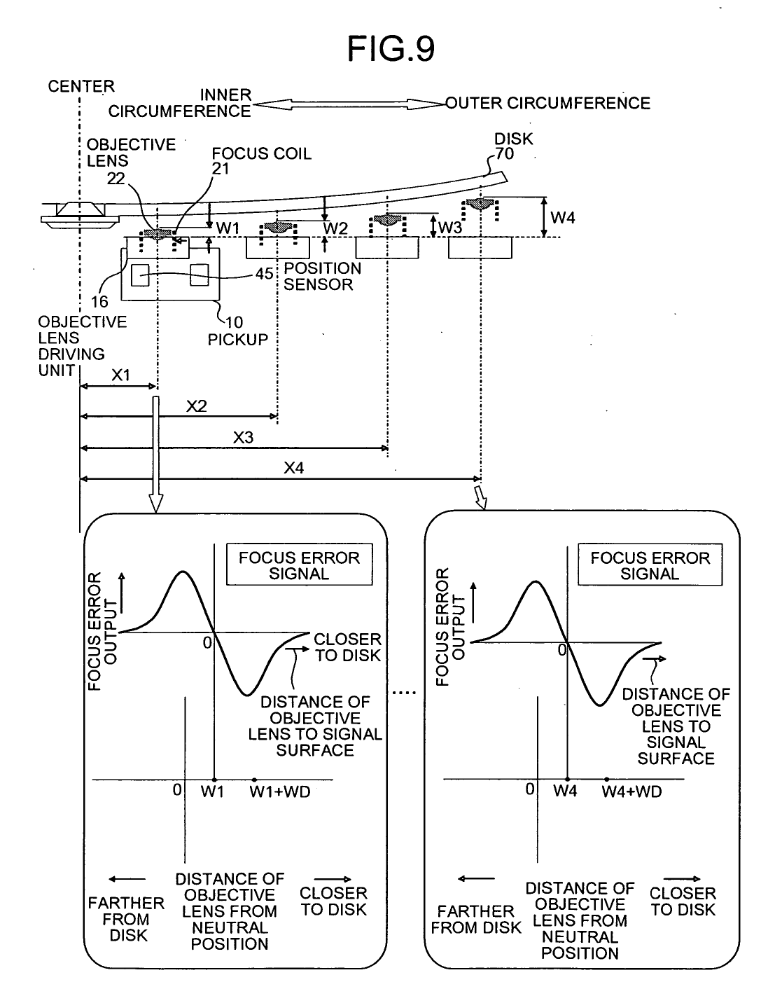

FIG. 9 is an explanatory view of the relationship between focus drive currents and in-focus states calculated by the disk-collision avoiding device. The pickup 10 reads the information recorded on the optical disk 70 while the optical disk 70 is rotated. The signal detecting unit 15 detects focus error signals at a plurality of positions X1 to Xn, respectively from the inner position (X1) to the outer position (Xn (where n is a natural number). The position sensor 45 detects positions of the objective lens 22 relative to the objective-lens driving unit 16. The moving distance calculating unit 42 calculates distances between the objective-lens driving unit 16 and the objective lens 22 at the respective positions detected by the position sensor 45.

At the position Xn, if the distance between the objective-lens driving unit 16 and the objective lens 22 is Wn, it is assumed that the objective lens 22 is in an in-focus state. It is also assumed that the distance Wn between the objective-lens driving unit 16 and the objective lens 22 is a distance (distance from the neutral position) by which the objective lens 22 is moved from the position of the objective lens 22 relative to the objective-lens driving unit 16 when the focus servo control is open (inoperative) to the position in the in-focus state.

In the second embodiment, the following instance will be explained. The signal detecting unit 15 detects F the focus error signal at the four positions (from the inner position (X1) to the outer position (X4) in the plane direction parallel to the surface of the optical disk 70. The moving distance calculating unit 42 calculates distances W1 to W4 between the objective-lens driving unit 16 and the objective lens 22 corresponding to the focus error signal of zero at the respective positions X1 to X4.

Because of a difference in shape among a plurality of optical disks 70, distances by which the objective lens 22 is moved from the objective-lens driving unit 16 to irradiate the light beam with optimum focal point onto the optical disk 70 at the respective positions X1 to X4 differ among the optical disks 70. Furthermore, because of the warping or the like of the optical disk 70 on the surface of even one optical disk 70, the distances differ according to the radial positions of the objective lens 22.

In the second embodiment, the signal detecting unit 15 detects the focus error signal first at the position X1, and the moving distance calculating unit 42 calculates the distance between the objective-lens driving unit 16 and the objective lens 22 at the position X1. In addition, the radial-position detecting unit 34 acquires the information on the position X1 at which the focus error signal is detected, and transmits the information to the focus control unit 35.

The pickup 10 is then moved to the radial position X2 other than the position X1 in the plane direction parallel to the surface of the optical disk 70. At the position X2, similarly to the position X1, the signal detecting unit 15 detects the focus error signal, and the moving distance calculating unit 42 calculates the distance between the objective-lens driving unit 16 and the objective lens 22. In addition, the radial-position detecting unit 34 acquires information on the position X2 and transmits the information to the focus control unit 35.

The pickup 10 is further moved to the other radial positions X3 and X4 in the plane direction parallel to the surface of the optical disk 70. The signal detecting unit 15 detects the focus error signal at the positions X3 and X4, respectively. The moving distance calculating unit 42 calculates the distances between the objective-lens driving unit 16 and the objective lens 22 at the respective positions X3 and X4. The radial-position detecting unit 34 acquires information on the respective positions X3 and X4, and transmits the information to the focus control unit 35. At the positions X1 to X4, the distances between the pickup 10 and the objective lens 22 when the focus error signal is equal to zero correspond to the distances W1 to W4 between the objective-lens driving unit 16 and the objective lens 22, respectively.

The storing unit 37 of the focus control unit 35 stores therein the distances W1 to W4 between the objective-lens driving unit 16 and the objective lens 22 in the in-focus state at the respective positions X1 to X4 as the information on the shape (warping) of the optical disk 70.

A distance WD between the objective lens 22 and the surface of the optical disk 70 when the focus error output is equal to zero (in the in-focus state) is calculated. By doing so, the distances between the objective-lens driving unit 16 and the objective lens 22 (hereinafter, “collision moving distances”) (W1+WD) to (W4+WD) if the objective lens 22 collides against the surface of the optical disk 70 at the positions X1 to X4 can be calculated, respectively.

This makes it possible to calculate the collision moving distances corresponding to all the radial positions of the optical disks 70 by the linear interpolation or the like based on the relationship between the collision moving distances (W1+WD) to (W4+WD) and the positions X1 to X4, respectively.

The threshold calculating unit 36 calculates the collision moving distances corresponding to all the radial positions on the surface of the optical disk 70 based on the relationship between the collision moving distances (W1+WD) to (W4+WD) and the positions X1 to X4, respectively as information on thresholds of the distances between the objective-lens driving unit 16 and the objective lens 22. The threshold calculating unit 36 stores the calculated threshold information in the storing unit 37.

Subsequently, similarly to the first embodiment, the focus control unit 35 transmits, to the focus driving unit 31, information on a command to avoid the collision between the objective lens 22 and the optical disk 70 if the moving amount of the objective lens 22 calculated by the moving distance calculating unit 42 exceeds the threshold of the moving distance calculated in advance during the reproducing processing on the optical disk 70. The focus driving unit 31 applies a predetermined current to the focus coil 21 in response to the command information from the focus control unit 35. In addition, the focus driving unit 31 controls the position of the objective lens 22 to avoid the collision between the objective lens 22 and the optical disk 70.

In this manner, according to the second embodiment, the thresholds of the focal direction distances between the objective-lens driving unit 16 and the objective lens 22 are calculated before the recording or reproducing processing on the optical disk 70. Therefore, during the recording or reproducing processing on the optical disk 70, the irradiation direction distance of the objective lens 22 to the optical disk 70 can be calculated by detecting the distance between the objective-lens driving unit 16 and the objective lens 22. This makes it possible to reduce misdetection of the irradiation direction distance of the objective lens 22 to the optical disk 70. Therefore, the collision between the objective lens 22 and the optical disk 70 can be accurately estimated and the collision can be avoided. Furthermore, even while the focus servo control is open (inoperative), the collision between the objective lens 22 and the optical disk 70 can be avoided by detecting the focal direction distance of the objective lens 22 relative to the optical disk 70.

### Third Embodiment

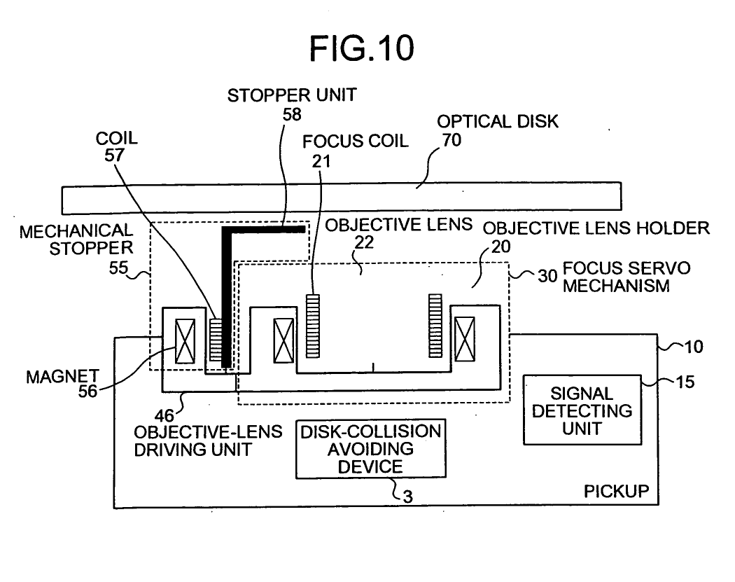

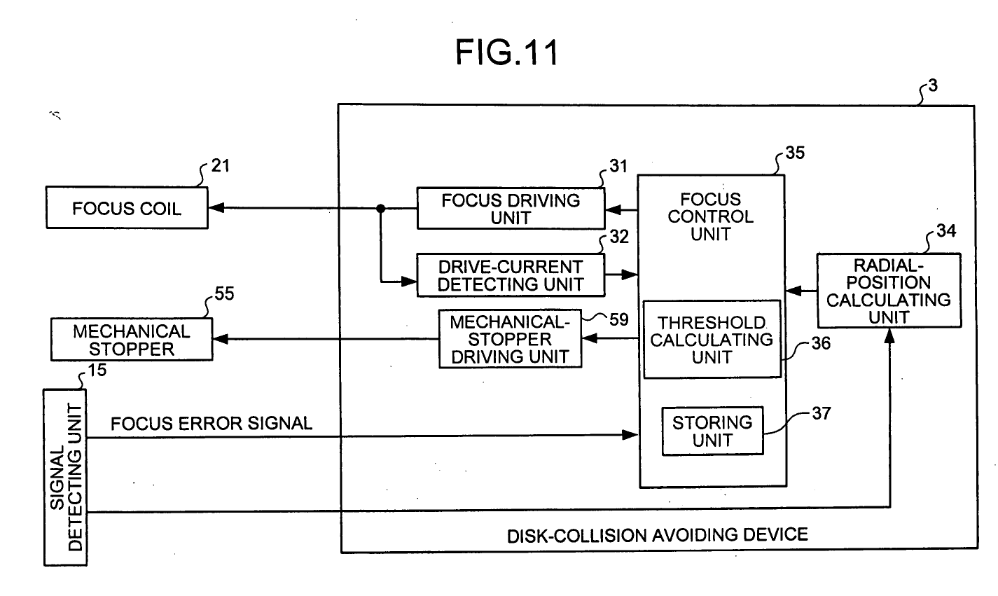

A third embodiment of the present invention will be explained with reference to FIGS. 10 and 11. In the third embodiment, a position of a movable mechanical stopper is controlled to avoid the collision between the objective lens 22 and the optical disk 70. FIG. 10 is a schematic of a pickup according to the third embodiment. FIG. 11 is a block diagram of a disk collision avoiding device. In FIGS. 10 and 11, constituent elements that perform the same functions as those of the pickup 10 according to the first embodiment shown in FIG. 1 and the disk collision avoiding device according to the first embodiment shown in FIG. 2 are denoted by the same reference symbols, and will not be repeatedly explained.

As shown in FIG. 10, the objective-lens driving unit 46 of the pickup 10 includes a mechanical stopper (movable stopper) 55. The mechanical stopper (movable stopper) 55 includes a magnet 56, a coil 57, and a stopper unit 58. The stopper unit 58 of the mechanical stopper 55 stops the movement of the objective lens 22 to prevent the objective lens 22 from being moved by a distance larger than a predetermined distance relative to the pickup 10. An electromagnetic force is generated on the coil 57 of the mechanical stopper 55 by causing the focus control unit 35 to apply a current to the coil 57. The stopper unit 58 connected to the coil 57 is moved on the objective-lens driving unit 46 in the light-beam irradiation direction by an attraction force or a repulsive force between the electromagnetic force and the coil 57.

As shown in FIG. 11, a disk collision avoiding device 3 includes a mechanical stopper driving unit 59. The mechanical stopper driving unit 59 is connected to the mechanical stopper 55. By applying the current to the coil 57 of the mechanical stopper 55, the mechanical stopper driving unit 59 drive-controls movement of the stopper unit 58 relative to the pickup 10.

In the third embodiment, if the focus drive current calculated by the drive-current detecting unit 32 exceeds the threshold of the corresponding collision drive current calculated in advance during the reproducing processing on the optical disk 70, the focus control unit 35 transmits, to the mechanical stopper driving unit 59, information on a command to move the stopper unit 58 to a position at which the objective lens 22 does not collide with the optical disk 70. The mechanical stopper driving unit 59 controls the position of the stopper unit 58 by controlling the current applied to the coil 57, and avoids the collision between the objective lens 22 and the optical disk 70. For instance, if a focus drive current Iz calculated by the drive-current detecting unit 32 exceeds the collision drive current (I1+Iwd) calculated in advance at the position X1 during the reproducing processing on the optical disk 70, the mechanical stopper driving unit 59 moves the stopper unit 58 to a position at which the objective lens 22 is moved from the position in the in-focus state to a position at which a moving distance of the objective lens 22 does not exceed the distance WD in a direction of the optical disk 70.

By doing so, even if the focus drive current detected by the drive-current detecting unit 32 exceeds the threshold of the corresponding focus drive current calculated in advance during the reproducing processing on the optical disk 70, the objective lens 22 collides only against the stopper unit 58. The collision between the objective lens 22 and the optical disk 70 can be, therefore, avoided. Alternatively, the pickup 10 according to the second embodiment may include the mechanical stopper 55, and the disk collision avoiding device 2 may include the mechanical stopper driving unit 59.

In this manner, according to the third embodiment, even if the focus drive current exceeds the threshold of the corresponding focus drive current calculated in advance during the reproducing processing on the optical disk 70, the position of the stopper unit 58 in the irradiation direction is controlled. Therefore, the objective lens holder 20 or the like collides only against the stopper unit 58, and it is possible to ensure avoiding the collision of the objective lens 22 against the optical disk 70.

1-8. (canceled)

9. An optical pickup device configured to any one of read data from and write data on an optical recording medium by using an objective lens, the optical pickup device comprising:
a shape-information obtaining unit that obtains shape information indicative of shape of the optical recording medium in a direction perpendicular to a plane of the optical recording medium, wherein the shape-information obtaining unit obtains the shape information before data is read from or written on the optical recording medium;
a limit setting unit that sets a plurality of distance limits corresponding to each of a plurality of positions on the optical recording medium based on the shape information obtained by the shape-information obtaining unit; and
a controlling unit that provides a control so that a relative distance between the objective lens and the optical recording medium is not less than a distance limit corresponding to a current position of the objective lens on the optical recording medium.

10. The optical pickup device according to claim 9, further comprising an actuator that holds the objective lens and moves the objective lens on the optical recording medium, wherein
the controlling unit varies a drive current applied to the actuator to provide the control.

11. The optical pickup device according to claim 9, further comprising a stopper member capable of moving in the direction perpendicular to the plane of the optical recording medium, and abutting the objective lens, wherein
the controlling unit controls the position of the stopper member to provide the control.

12. The optical pickup device according to claim 9, further comprising:
an actuator that holds the objective lens and moves the objective lens on the optical recording medium;
a signal detecting unit that detects a focus error signal produced when the objective lens is moved in the direction perpendicular to the plane of the optical recording medium; and
a drive-current detecting unit that detects a drive current currently applied to the actuator, wherein
the shape-information obtaining unit obtains the shape information based on the focus error signal detected by the signal detecting unit and the drive current detected by the drive-current detecting unit.

13. The optical pickup device according to claim 12, wherein the limit setting unit sets a distance limit corresponding to a first position based on a first drive current necessary to move the objective lens from a current position of the objective lens to a second position at which the focus error signal is equal to zero, and on a second drive current necessary to move the objective lens from the second position to the first position.

14. The optical pickup device according to claim 9, further comprising:
an actuator that holds the objective lens and moves the objective lens on the optical recording medium;
a signal detecting unit that detects a focus error signal produced when the objective lens is moved in the direction perpendicular to the plane of the optical recording medium; and
a distance measuring unit that measures a focus distance indicative of a relative distance of the objective lens with respect to the actuator, wherein
the shape-information obtaining unit obtains the shape information based on the focus error signal detected by the signal detecting unit and the focus distance measured by the distance measuring unit.

15. The optical pickup device according to claim 14, wherein the limit setting unit sets a distance limit based on a focus distance at a first position where the focus error signal is equal to zero and an object distance at the first position, wherein the object distance is a distance between the objective lens and a surface of the optical recording medium.

16. A method of preventing collision between an objective lens and an optical recording medium, the objective lens being moved over the optical recording medium to any one of read data from and write data on the optical recording medium, the method comprising:
obtaining shape information indicative of shape of the optical recording medium in a direction perpendicular to a plane of the optical recording medium, wherein the obtaining is performed reading data from or writing data on the optical recording medium;
setting a plurality of distance limits corresponding to each of a plurality of positions on the optical recording medium based on the shape information obtained at the obtaining; and
providing a control so that a relative distance between the objective lens and the optical recording medium is not less than a distance limit corresponding to a current position of the objective lens on the optical recording medium.
